(19) United States
(12) Patent Application Publication
(10) Pub. No.: US 2008/0091486 A1
(43) Pub. Date: Apr. 17, 2008

(54) Program, method, and apparatus for analyzing group work activities in a project

(75) Inventors: Kouji Aoyama, Kawasaki (JP); Hiroaki Harada, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: Fujitsu Limited, Kawasaki-shi (JP)

(21) Appl. No.: 11/799,729

(22) Filed: May 2, 2007

(30) Foreign Application Priority Data
Oct. 11, 2006 (JP) 2006-277075

(51) Int. Cl. G06Q 10/00; G06F 17/40

(52) U.S. Cl. 705/7

(57) ABSTRACT

A computer program, method, and apparatus serving as a tool for analyzing teamwork activities performed by a group of workers at a particular workplace during a particular time period, based on actual work log records of individual workers. In response to a teamwork analysis request specifying a group of workers, a teamwork finder extracts two workers' individual work log records having overlapping work periods. If their other data fields coincide at least in part, the teamwork finder finds the extracted log records to be of a teamwork activity. A teamwork log generator produces teamwork log records from the individual work log records identified as being of teamwork activities. The produced teamwork log records are then stored in a teamwork log database.

### CROSS-REFERENCE TO RELATED APPLICATIONS

This application is based upon and claims the benefits of priority from the prior Japanese Patent Application No. 2006-277075 filed Oct. 11, 2006, the entire contents of which are incorporated herein by reference.

### BACKGROUND OF THE INVENTION

1. Field of the Invention

The present invention relates to a computer program stored in a computer-readable medium, as well as to a method and apparatus, which serves as a tool for analyzing activities performed by a group of workers. More particularly, the present invention relates to a computer program, method, and apparatus for analyzing group work activities based on work logs of individual workers.

2. Description of the Related Art

Enterprises implement their business projects using a group-based approach involving multiple units of organization, rather than assigning every task to a single organizational unit. Think of, for example, sales of computer systems. The project involves not only sales staff, but also system engineers for software support, customer service engineers for hardware support, and other employees. The key for successful operation of this type of project is the efficient collaboration of different departments involved.

When a project is completed or has reached some intermediate point, the project members may have a meeting to review and discuss what they have accomplished successfully or unsuccessfully. In such a project wrap-up or review meeting, each member reports details of his/her work activities, including times spent for the project. The members can compare their activities with each other, sometimes finding an unnecessary duplication of tasks performed by two or more workers. Such an analysis may also reveal the fact that, for example, lack of immediate sharing of information has produced some extra works.

As a tool for analyzing activity records of individuals, several researchers have proposed a technique of visualizing chronologies of multiple persons. See, for example, Japanese Patent Application Publication No. 11-249640 (1999). The proposed technique displays each person's history from birth to date (e.g., their educational background and experience of studying abroad) in comparative form.

Another related technique is to produce records of collaborative activities on a computer in the order that they are performed. See, for example, Japanese Patent Application Publication No. 8-153077 (1996). Yet another related technique is to manage the progress of each work process of a particular worker, such that the entire view of his/her work can be obtained. See, for example, Japanese Patent Application Publication No. 2001-84305.

To improve business processes, it is important to analyze teamwork activities and group membership in an appropriate way. Note that the term “teamwork” refers not to mere involvement of multiple workers, but to a collaborative work process performed by a plurality of participants at a particular place and during a particular period. Successful teamwork does not necessarily call for many participants. Rather, a pointless infusion of staff to a group activity would only result in poor efficiency of individual workers. As another typical case of inefficiency is where a person with key responsibilities in decision making comes late. This would spoil the group's performance because the absence of a responsible person sometimes forces other group members to waste their time waiting.

As can be seen from the above discussion, the workers could find their problems more easily if they were able to identify teamwork activities from among activities of individual project workers. However, conventional tools in this technical area are focused on management of project work performed online, unable to handle offline activities such as face-to-face meetings and hardware installation of a newly introduced computer system.

One alternative technique for identifying teamwork activities is to use some online system to manage the work schedule of each project member. Although it appears practical to some extent, the ability of this technique is quite limited since discrepancies between schedule and reality are inevitable. In a wrap-up meeting of a project, the discussion has to focus on the actual work processes. To this end, it is important to have reliable records describing how much time was actually spent to achieve each particular task. It is pointless to review the project based on its planned schedule.

Because of the lack of computer-based analysis tools for group work activities, the wrap-up meeting requires project members to recall group activities based on their memory, notes, journals, email archives, or the like. Relying on ambiguous personal memory and notes, the meeting participants tend to spend a long time to recall exactly what they have done.

### SUMMARY OF THE INVENTION

In view of the foregoing, it is an object of the present invention to provide a computer program, method, and apparatus that serve as a tool for analyzing activities performed by a group of workers at a particular workplace during a particular time period, based on actual work log records of the individual workers.

To accomplish the above object, the present invention provides a computer-readable medium storing a program for analyzing group work activities. This program causes a computer to function as the following elements: an individual work log database, a teamwork finder, a teamwork log record generator, and a teamwork log database. The individual work log database stores individual work log records describing work activities performed by individual workers involved in a project. Each of the individual work log records contains a worker ID, work period, and other data fields. In response to a teamwork analysis request specifying a group of workers, the teamwork finder extracts two workers' individual work log records having overlapping work periods. If the other data fields thereof coincide at least in part, the teamwork finder finds the extracted individual work log records to be of a teamwork activity. The teamwork log generator produces teamwork log records from the individual work log records identified as being of teamwork activities. The produced teamwork log records are then stored in the teamwork log database.

Also to accomplish the above object, the present invention provides a method of analyzing group work activities. This method includes the following steps: (a) storing, in an individual work log database, individual work log records describing work activities performed by individual workers involved in a project, wherein each of the individual work log records contains a worker ID, work period, and other data fields; (b) in response to a teamwork analysis request specifying a group of workers, extracts two workers' individual work log records having overlapping work periods and finding the extracted individual work log records to be of a teamwork activity if the other data fields thereof coincide at least in part; (c) producing teamwork log records from the individual work log records identified as being of teamwork activities; and (d) storing the produced teamwork log records in a teamwork log database.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 gives an overview of the present invention.

FIG. 2 is a block diagram of a system according to an embodiment of the present invention.

FIG. 3 shows an example hardware platform for a group work analyzer according to the present embodiment.

FIG. 4 is a block diagram showing functional components of the system according to the present embodiment.

FIG. 5 shows an individual work entry dialog.

FIG. 6 shows an example data structure of a user work log database.

FIG. 7 shows an example data structure of a personnel database.

FIG. 8 shows an example data structure of an individual work log database.

FIG. 9 is a flowchart of a process of producing a teamwork log.

FIG. 10 is a flowchart showing a process of finding a teamwork activity by comparing individual work log record pairs.

FIG. 11 shows various patterns of work periods.

FIG. 12 is a flowchart of a process of comparing workplaces.

FIG. 13 is a flowchart of a process of generating a teamwork log record.

FIG. 14 shows an example of a teamwork log record.

FIG. 15 shows individual work log records with a teamwork flag and a teamwork ID.

FIG. 16 shows a teamwork log database updated with a new participant name.

FIG. 17 shows the individual work log database that is updated.

FIG. 18 shows the teamwork log database with a new entry.

FIG. 19 shows the individual work log database with additional teamwork IDs.

FIG. 20 shows the teamwork log database with an additional teamwork participant.

FIG. 21 shows the teamwork log database after its records are sorted.

FIGS. 22 and 23 show examples of a group work history window.

### DESCRIPTION OF THE PREFERRED EMBODIMENTS

Preferred embodiments of the present invention will be described below with reference to the accompanying drawings, wherein like reference numerals refer to like elements throughout.

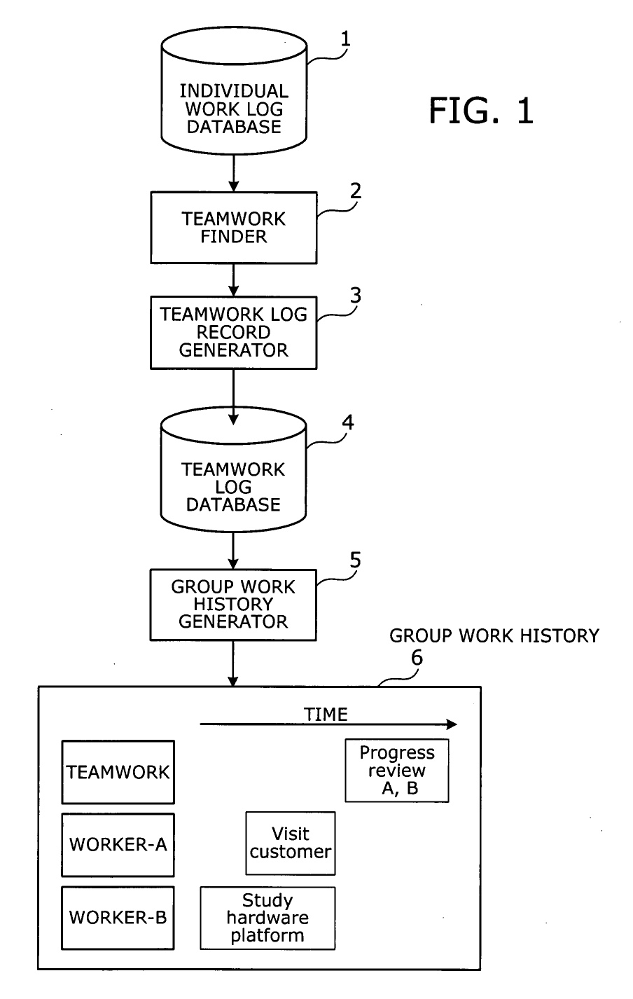

FIG. 1 gives an overview of the present invention. Specifically, FIG. 1 shows an individual work log database 1, a teamwork finder 2, a teamwork log record generator 3, a teamwork log database 4, and a group work history generator 5. Those components constitute a group work analyzer with the functions described below.

The individual work log database 1 stores individual work log records describing work activities performed by individual workers involved in a particular project. Each of the individual work log records contains a worker ID, work period, and other data fields describing each work activity that a worker has conducted. The other data fields not enumerated above are: a workplace field, a description field, and a coworker field.

The teamwork finder 2 is responsive to a teamwork analysis request specifying a group of workers. Upon receipt of such a request, the teamwork finder 2 compares one worker's individual work log records stored in the individual work log database 1 with another worker's. If the work periods described in two log records share an overlapping period, and if those two log records coincide at least partly in the other data fields, then the teamwork finder 2 finds the two log records to be of a teamwork activity. For example, the teamwork finder 2 discovers a teamwork activity in two log records if their work periods overlap and if their workplaces coincide. The teamwork finder 2 also flags an individual work log record as “individual” if there is no sign of teamwork activities in that record.

The teamwork log record generator 3 produces teamwork log records from individual work log records identified as being of teamwork activities. The produced teamwork log records are saved in a teamwork log database 4.

The group work history generator 5 sorts teamwork activities in chronological order, based on the teamwork log stored in the teamwork log database 4. The group work history generator 5 also retrieves individual work log records flagged as “individual” from the individual work log database 1 and sorts those individual work activities in chronological order. With the sorted data, the group work history generator 5 creates a group work history 6.

In operation, the group work analyzer receives a teamwork analysis request specifying a group of workers. Upon receipt, the teamwork finder 2 compares individual work log records of two workers. If their work periods overlap and if other data fields of the records coincide at least in part, the teamwork finder 2 determines that the two workers engaged in a teamwork activity. Such records of a teamwork activity are compiled into a teamwork log record and registered in the teamwork log database 4. Further, a group work history 6 is created to visualize the teamwork activities along with each worker's individual work activities.

The above-described group work analyzer serves as a useful tool for the project members to review their group activities performed in the course of the project. For comparison purposes, think of a conventional project wrap-up meeting. According to a conventional way of wrapping up a project, the project members need to recall group activities based on their memory, notes, journals, email archives, or the like. There are no tools for them to enumerate what they have done or analyze how they have collaborated. The lack of efficient tools makes it difficult to picture the entire process of project work, particularly in determining where the problem (if any) lies, in their way of collaboration or in their individual work processes. The present invention helps them to review the entire project and isolate problems, by automatically producing a group work history 6 that visualizes teamwork activities and individual activities in an organized way.

### Client Implementation

Preferably, the mechanism of collecting individual work log records is implemented as a function of client computers on which the workers carry out their project work. Records are accumulated in each client, which can later be gathered for analysis. The following specific embodiment of the present invention assumes this system model.

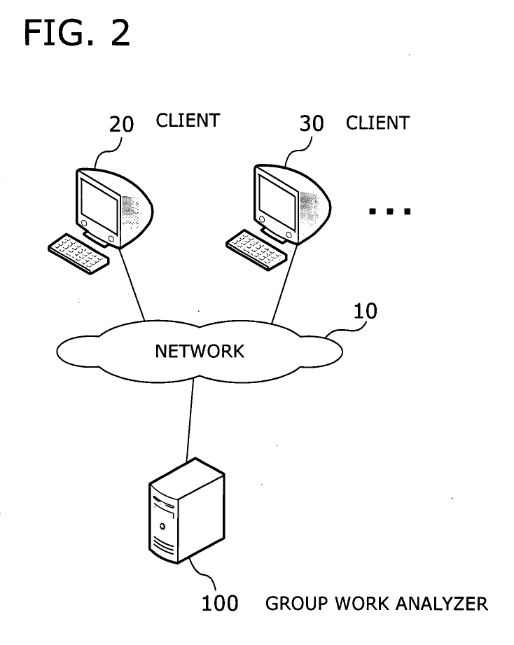

FIG. 2 is a block diagram of a system according to an embodiment of the present invention. The illustrated group work analyzer 100 works with a plurality of client computers (or simply “clients”) 20, 30, and so on connected through a network 10. From those clients 20 and 30 and others, the group work analyzer 100 collects individual work logs of workers involved in a particular project and compiles them into a work history of that project. In the process of creating a work history, the group work analyzer 100 classifies work activities into individual work activities and teamwork activities. The created work history is sent to each worker's client 20, 30, and so on for the purpose of viewing.

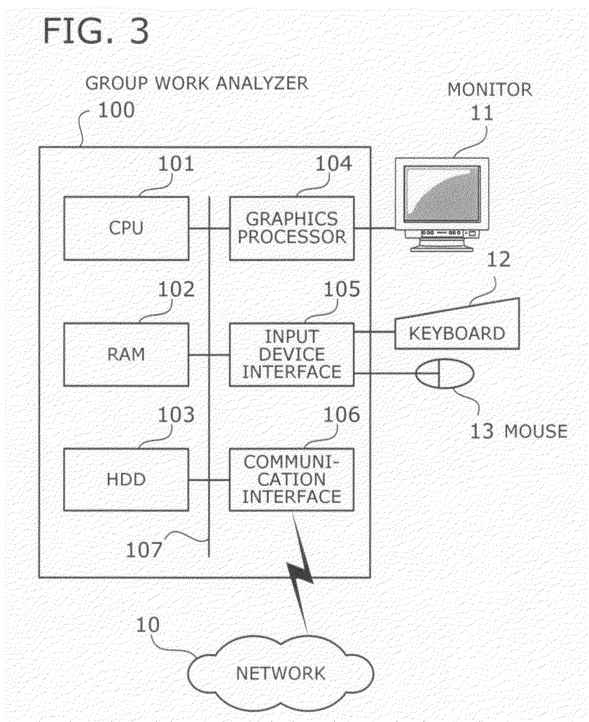

FIG. 3 shows an example hardware platform for the group work analyzer 100 according to the present embodiment. The illustrated group work analyzer 100 includes the following functional elements: a central processing unit (CPU) 101, a random access memory (RAM) 102, a hard disk drive (HDD) 103, a graphics processor 104, an input device interface 105, and a communication interface 106. The CPU 101 controls the entire system of this group work analyzer 100, interacting with other elements over a bus 107.

The RAM 102 serves as temporary storage for the whole or part of operating system (OS) programs and application programs that the CPU 101 executes, in addition to other various data objects manipulated at runtime. The HDD 103 stores program and data files of the operating system and various applications. The graphics processor 104 produces video images in accordance with drawing commands from the CPU 101 and displays them on the screen of an external monitor 11 coupled thereto. The input device interface 105 is used to receive signals from external input devices, such as a keyboard 12 and a mouse 13. Those input signals are supplied to the CPU 101 via the bus 107. The communication interface 106 is connected to a network 10, allowing the CPU 101 to exchange data with other computers (not shown) on the network 10.

The computer system described above serves as a hardware platform for realizing the processing functions of the present embodiment. While FIG. 3 shows an example of the group work analyzer 100, the same hardware configuration can also be applied to the clients 20, 30, and so on.

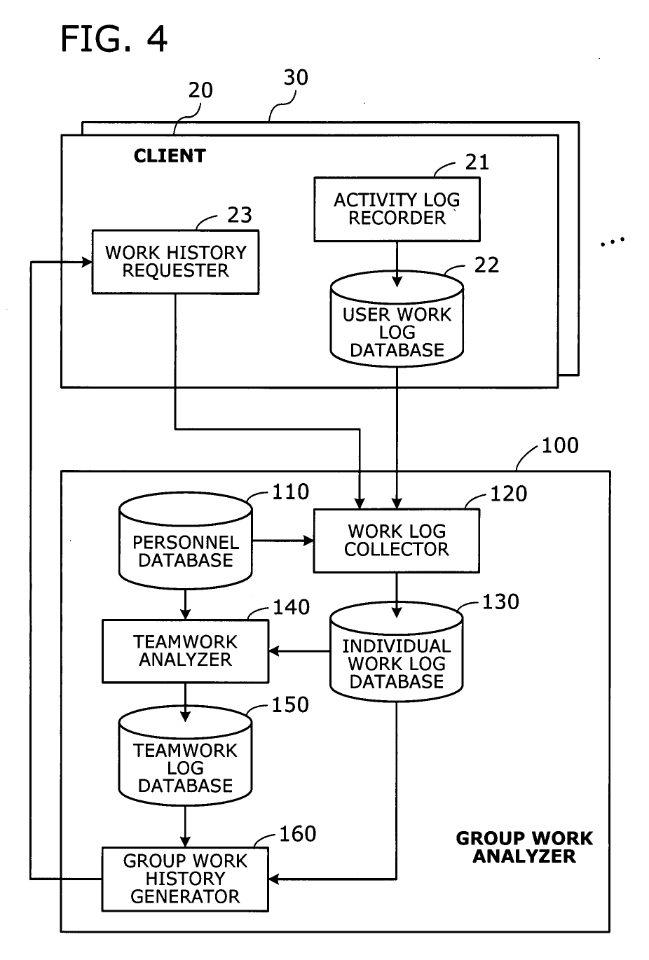

FIG. 4 is a block diagram showing functional components of the system according to the present embodiment. Specifically, the client 20 includes an activity log recorder 21, a user work log database 22, and a work history requester 23. While not explicitly shown in FIG. 4, the client 30 and others have the same functions as the client 20 illustrated. Workers may engage in online work using computers such as clients 20 and 30. They may also work without using a computer. The former type of work are referred to as online activities, and the latter offline activities. The activity log recorder 21 in the client 20 collects records of both online and offline activities of the user of the client 20 and stores them in the user work log database 22. The activity log recorder 21 can detect the user's online activities by monitoring applications running on the client 20. Suppose, for example, that the user has launched an email client. The activity log recorder 21 finds this event to be the beginning of an online activity of the user and thus tracks the process until the email client is terminated by the user. The activity log recorder 21 creates an individual work log record with a description field containing a value of “email” and with a work period field indicating the duration. Note, however, that the activity log recorder 21 does not record all activities of the email client. For example, no log records are produced when the email client is performing a background operation to check the user's inbox.

The Applicants of the present invention have proposed a technique to collect activity records by identifying the worker's location and deducing his/her activity from that location. Details are disclosed in Japanese Patent Application No. 2006-77691, the entire contents of which are incorporated herein by reference. The proposed technique can be applied to the client 20 to automate the process of collecting individual work log records of offline activities. Suppose, for example, that there is a rule requiring every worker entering or leaving a meeting room to insert his/her ID card to the card reader at the door so that his/her ID code can be checked. In this case, the ID code collected through the card reader indicates presence of the worker (i.e., card owner) in the meeting room. Instead of ID cards, cellular phones may be used to locate workers in the case where every worker is supposed to carry a cellular phone with him/her. Since signals transmitted by cellular phones are received by some nearest cellular base stations, it is possible to calculate the location of a worker from received signal strengths. Those are examples of how each worker's location can be tracked. When a worker's presence in a meeting room is observed for a certain period, the worker is supposed to have attended some meeting held in that room during the time period between his/her entry and exit.

With the above-described technique implemented, the activity log recorder 21 produces individual work log records for each worker's offline work activities. The produced records are then entered to the user work log database 22.

The activity log recorder 21 further offers the function of editing individual work log records stored in the user work log database 22. That is, the activity log recorder 21 helps the user to create an entry for the individual work log and register it in the user work log database 22. This function enables the user work log database 22 to accumulate work log records that cannot be collected automatically with the above-described activity tracking technique. The activity log recorder 21 also allows the user to edit the individual work log in the user work log database 22 to correct its contents if there is an error.

The user work log database 22 is a storage device for accumulating individual work log records of the worker using the client 20. For example, the HDD unit in the client 20 offers a storage space for this purpose. Each individual work log record describes a particular work activity of the user, including its workplace, time period, brief description, and others.

The work history requester 23 sends a work history creation request to the group work analyzer 100 in response to a command from the user. This work history creation request contains information specifying a particular worker as a group member. According to the present embodiment, an employee ID is used for the purpose. The work history creation request causes the group work analyzer 100 to produce and return a group work history to the requesting client 20, so that the work history requester 23 can display the received group work history on a monitor screen.

### Group Work Analyzer

The group work analyzer 100 is formed from a personnel database 110, a work log collector 120, an individual work log database 130, a teamwork analyzer 140, a teamwork log database 150, and a group work history generator 160.

The personnel database 110 is a collection of data of employees including project workers. Specifically, a part of the HDD 103 is assigned as a storage space for this personnel database 110. The data items may include: employee ID, name, department/unit, office location, and others.

The work log collector 120 is responsive to work history creation requests from clients. Upon receipt of a request specifying workers, the work log collector 120 retrieves individual work log records from the user work log database of each specified worker's client computer. The work log collector 120 saves the retrieved individual work log into the individual work log database 130.

The individual work log database 130 stores individual work log records of a plurality of workers. Specifically, a part of the HDD 103 is assigned as a storage space for this individual work log database 130.

The teamwork analyzer 140 retrieves individual work log records from the individual work log database 130 and compares them with each other in an attempt to find teamwork activities. By so doing, the teamwork analyzer 140 compiles relevant individual work log records into a teamwork log. In that process, the teamwork analyzer 140 classifies work activities into teamwork activities and individual work activities. The resulting teamwork log records are stored in the teamwork log database 150. That is, the teamwork analyzer 140 includes, among others, the functions of the teamwork finder 2 and teamwork log record generator 3 explained earlier in FIG. 1.

The teamwork log database 150 is a storage device where teamwork log records are stored. Specifically, a part of the HDD 103 is assigned as a storage space for this teamwork log database 150.

The group work history generator 160 produces a group work history based on the teamwork log records in the teamwork log database 150. The group work history generator 160 sends the produced group work history back to the requesting client. The group work history generator 160 includes the functions of the group work history generator 5 explained earlier in FIG. 1.

The above elements of the present embodiment produce a group work history by extracting teamwork activities from collected individual work log records and displays it on a client computer screen.

### Individual Work Log Collection

This and subsequent sections will describe in greater detail how the present embodiment operates, beginning with how it registers individual work log records. As mentioned earlier, individual work log records are registered in the user work log database 22 by the activity log recorder 21. To this end, the activity log recorder 21 has the function of deducing a worker's offline activity from his/her behavior. The following description, however, assumes that the worker enters data of his/her work activities into the activity log recorder 21 manually.

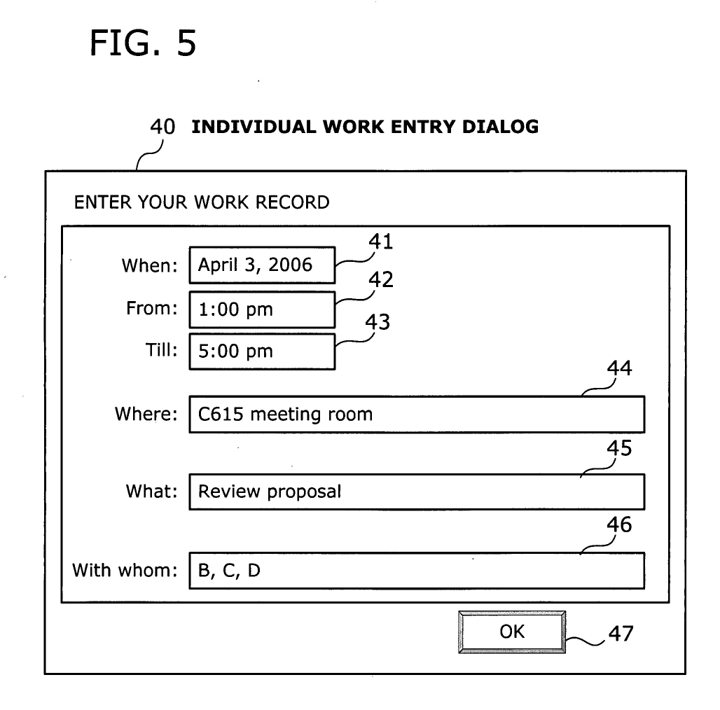

FIG. 5 shows an individual work entry dialog 40. This dialog 40 appears on a monitor screen of the client 20 as one of the functions the activity log recorder 21 offers. The individual work entry dialog 40 is formed from the following components: a date entry box 41 (with a caption “When”), a start time entry box 42 (“From”), an end time entry box 43 (“Till”), a workplace entry box 44 (“Where”), a description entry box 45 (“What”), a coworker name entry box 46 (“With whom”), and an OK button 47.

The date entry box 41 is a text box for the user, or the worker, to enter the date of a specific activity that he/she performed. The start time entry box 42 is a text box for the use to enter the time when the activity started. The end time entry box 43 is a text box for the worker to enter the time when the activity finished. The worker enters data into those three data entry boxes 41 to 43, thereby giving information on the time period of his/her work activity.

The workplace entry box 44 is a text box for the worker to describe where the activity took place. In the case of a meeting, for example, the worker is supposed to enter the room number of the meeting room to the workplace entry box 44. In the case of a trip, the worker would describe the destination in the workplace entry box 44.

The description entry box 45 is a text box for the worker to give a brief description of the activity. FIG. 5 shows an entry of “Review proposal” as an example of activity description. Workers may take a trip by train or the like from one office to another. The activity description in that case would be “Move.”

Workers are expected to describe their work plainly and specifically. Suppose, for example, that a meeting is announced with a specific agenda. After the meeting, each participant records his/her attendance to the meeting in the form of an individual work log record, filling in the description entry box 45 with the subject of the meeting.

The coworker name entry box 46 is a text box for entering the names of coworkers in the case where he/she has worked with other project members. The coworker name entry box 46 accepts a plurality of names.

The OK button 47 is used to send the data entered in the individual work entry dialog 40 to the user work log database 22. When the OK button 47 is pressed, the activity log recorder 21 creates an individual work log record from what the worker has entered to the individual work entry dialog 40 and adds that new record to the user work log database 22.

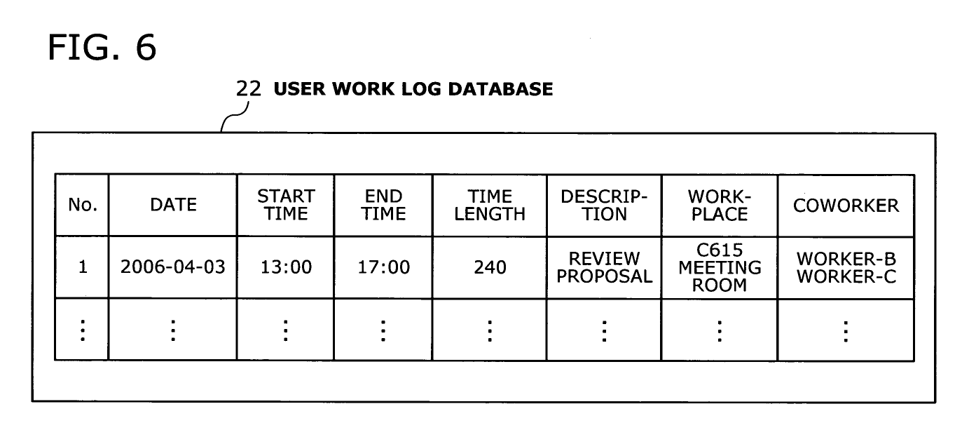

FIG. 6 shows an example data structure of the user work log database 22. Specifically, the user work log database 22 is illustrated in the form of a table with the following data fields: “Log Number” (“No.”), “Date,” “Start Time,” “End Time,” “Time Length,” “Description,” “Workplace,” and “Coworker.” Each row (i.e., a set of associated data fields) of this table constitutes a single record representing a particular individual work activity.

The log number field contains an identification code that is given to an individual work log record. The date field shows the date of the work activity described by the record. The start time and end time fields indicate when the activity started and ended, respectively, and the time length field gives its duration in units of minutes. The description field gives a brief description of the activity. The workplace field shows where the activity took place. The coworker field shows the names of other workers involved in the activity.

The activities of workers are logged individually in their clients 20, 30, and so on during a project. When the project is completed or has reached some point appropriate for a mid-project review, the worker using the client 20 commands its work history requester 23 to display a group work history. Specifically, the worker enters the following parameters to the work history requester 23: the number of group membership, group work period, and group member IDs. More specifically, the membership parameter should be a natural number equal to or greater than one. The group work period is specified by start and end dates. For the third parameter, the worker enters as many employee IDs as the number of group membership.

Upon entry of the above parameters, the work history requester 23 issues a work history creation request to the group work analyzer 100. This request causes the work log collector 120 in the group work analyzer 100 to retrieve individual work log records from the user work log database of each client 20, 30, and so on. The specified group member IDs and start/end date parameters are used to select relevant log records of group members during the specified group work period.

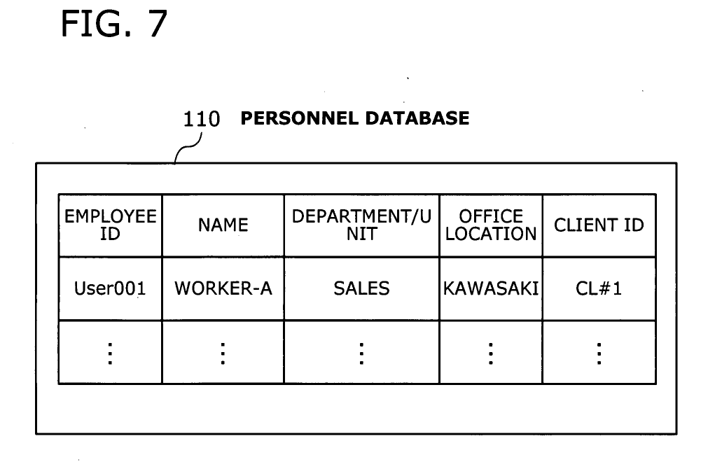

To achieve the above record retrieval process, the work log collector 120 needs to know which client computer each group member is using. The work log collector 120 consults a personnel database 110 to obtain this information. FIG. 7 shows an example data structure of the personnel database 110. Specifically, FIG. 7 illustrates the personnel database 110 in the form of a table having the following data fields: “Employee ID,” “Name,” “Department/Unit,” “Office Location,” and “Client ID.” Each row (i.e., a set of associated data fields) of this table constitutes a single record describing a particular employee.

The employee ID field contains an employee ID of an employee, and the name field his/her name. The department/unit field describes to which organizational unit he/she belongs, and the office location field shows where his/her office is. The Client ID field indicates the name or address of a client that the employee is using, so that the client can be identified uniquely on the network 10.

The work log collector 120 searches the personnel database 110 for employee data corresponding to a specific employee ID given in the received work history creation request. Upon finding employee data of a specified group member, the work log collector 120 extracts a client ID value from the corresponding data field of that data. The work log collector 120 uses this client ID to make access to the group member's client and retrieve work log records from its user work log database. Note that this step only selects work log records qualified by the group work period parameter specified in the work history creation request. The work log collector 120 executes the above tasks for every group member specified in the work history creation request and saves the resulting set of work log records in the individual work log database 130.

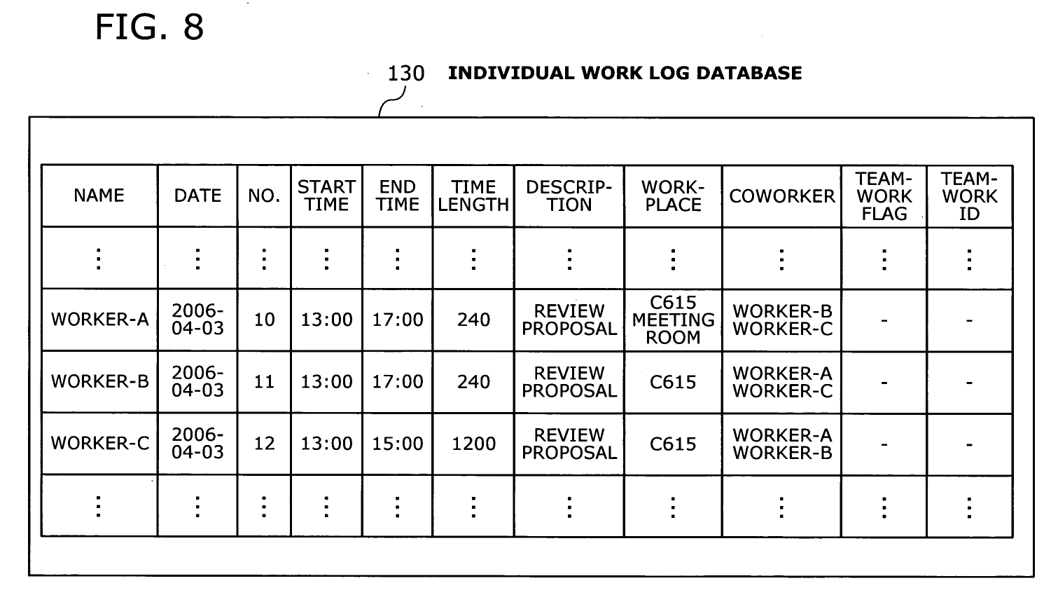

FIG. 8 shows an example data structure of the individual work log database 130. The individual work log database 130 has the following data fields: Name,” “Date,” “No.” (number), “Start Time,” “End Time,” “Time Length,” “Description,” “Workplace,” “Coworker,” “Teamwork Flag,” and “Teamwork ID.”

The name field contains the name of a worker. The date field shows when the individual work activity took place. The number field contains a record identifier that is unique within the individual work log database 130. The start time and end time fields show when the activity began and finished, and the time length field gives its duration in units of minutes. The description field gives a brief description of the activity. The workplace field shows where the activity took place. The coworker field shows the names of other workers involved in the activity.

The teamwork flag field and teamwork ID field will receive specific values when it is determined whether the log record is of a teamwork activity or an individual work activity. More specifically, the teamwork flag field contains a flag indicating whether the activity is a teamwork activity. According to the present embodiment, the flag is set to one when the present log record is of a teamwork activity. The flag is otherwise set to zero, indicating that the present log record is of an individual work activity.

### Main Process

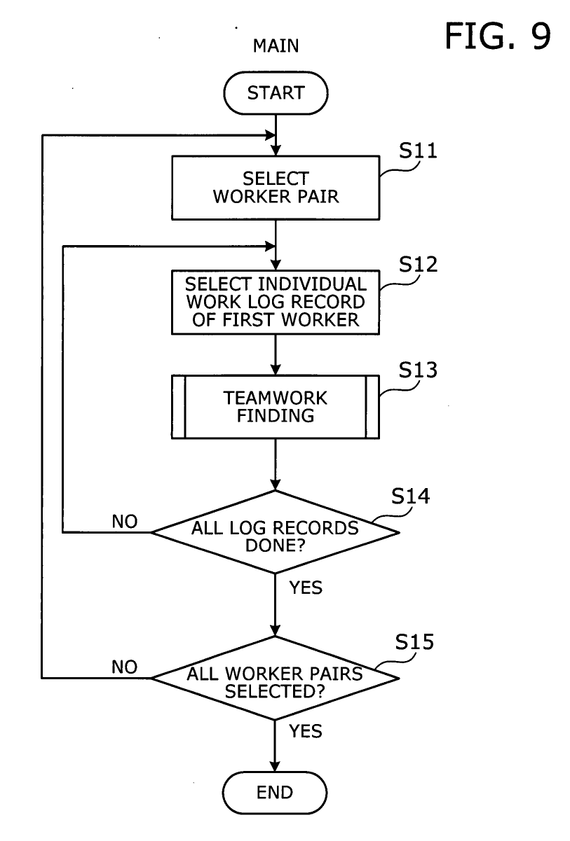

The collected individual work log records are then subjected to the teamwork analyzer 140 to produce a teamwork log. FIG. 9 is a flowchart of a main process of producing a teamwork log. This process proceeds according to the following steps:

(Step S11) The teamwork analyzer 140 selects one of the group members as a first worker. The teamwork analyzer 140 then selects another one of the group members as a second worker for comparison with the first worker.

(Step S12) The teamwork analyzer 140 selects one of the individual work log records of the first worker.

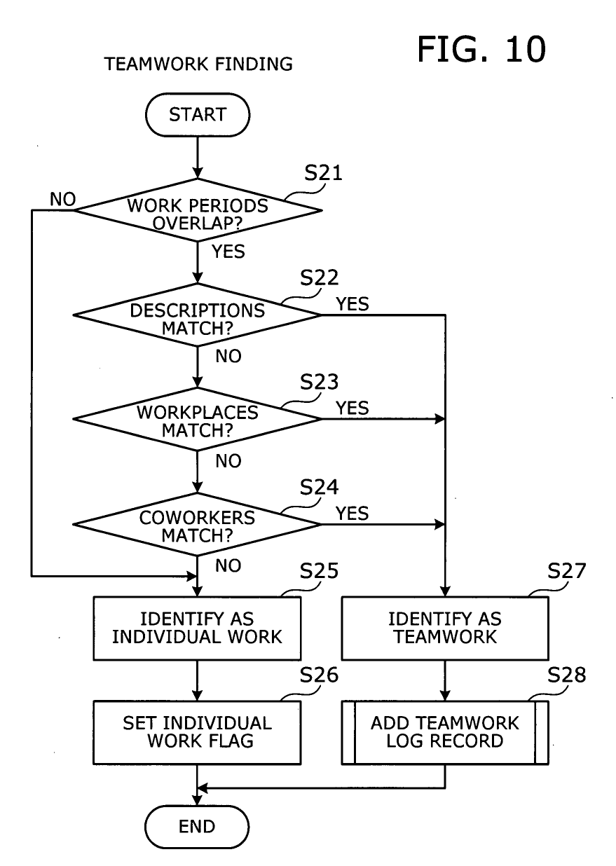

(Step S13) The teamwork analyzer 140 subjects the record selected at step S12 and the individual work log records of the second worker to a teamwork finding process (details described later in FIG. 10).

(Step S14) The teamwork analyzer 140 determines whether all individual work log records of the first worker have been processed at step S13. If there are remaining records, the process returns to step S12 to select a new record. If all records have been processed, the process advances to step S15.

(Step S15) The teamwork analyzer 140 determines whether every group member pair has undergone the teamwork finding process of step S13. If there remain unfinished pairs, the process returns to step S11. If every pair has undergone, the teamwork analyzer 140 terminates the process.

The above-described steps of FIG. 9 discover teamwork activities performed by two group members during a specified group work period. Referring now to the flowchart of FIG. 10, the following will give details of the teamwork finding process called at step S13 of FIG. 9. The process of FIG. 10 proceeds according to the following steps:

(Step S21) The teamwork analyzer 140 compares work periods between the selected work log record of the first worker with every individual work log record of the second. Here the term “work period” refers to the time period between the start time and end time described in an individual work log record. The comparison permits the teamwork analyzer 140 to extract individual work log records whose work periods overlap wholly or partly. If such log records are found, the process advances to step S22. If no such log records are found, the process skips to step S25.

(Step S22) Now that two individual work log records having overlapping work periods are found, the teamwork analyzer 140 then compares their descriptions. If the descriptions match with each other, the process branches to step S27. If not, the process proceeds to step S23.

(Step S23) The teamwork analyzer 140 then compares workplaces of the two individual work log records in question. The teamwork analyzer 140 determines the degree of matching in the way described later. If the two workplaces match, the process branches to step S27. If they do not match, the process advances to step S24.

(Step S24) The teamwork analyzer 140 compares coworker names found in the two individual work log records in question. The coworker names in this case include all workers described in either the coworker field or the name field. The teamwork analyzer 140 determines whether the two records match in the entirety of those coworker names. If they match, the process branches to step S27. If there is a name that is found only in one record, the process advances to step S25.

(Step S25) The teamwork analyzer 140 concludes that the selected log record of the first worker describes an individual work activity.

(Step S26) The teamwork analyzer 140 sets an individual work flag (actually, sets a teamwork flag to zero) to indicate the findings of step S25 and exits from the present process.

(Step S27) The teamwork analyzer 140 determines that the selected log record of the first worker describes a teamwork activity.

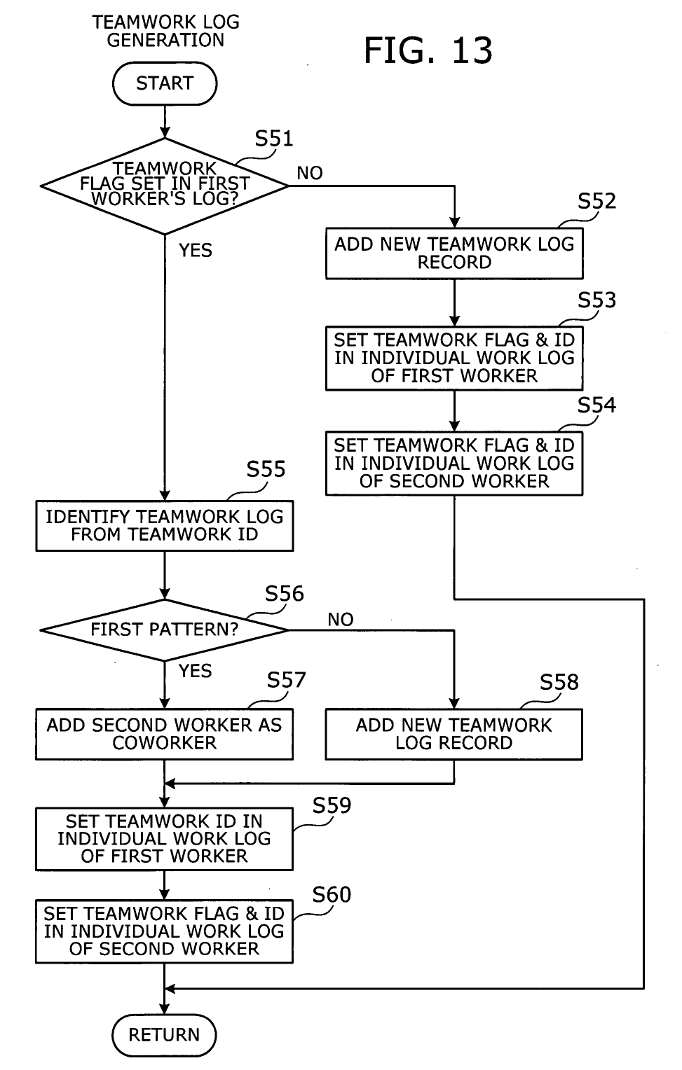

(Step S28) The teamwork analyzer 140 updates the teamwork log, based on the first worker's log record that is currently selected and the second worker's log record with an overlapping work period. The detail of this step will be described later with reference to FIG. 13.

The above-described steps discover teamwork activities by selecting individual work log records of two workers whose work periods overlap and further extracting those that match in either of the description, workplace, and coworker data fields. While the flowchart of FIG. 10 compares descriptions (S22), workplaces (S23), and then coworkers (S24) in that order, the present invention is not limited to that specific order of comparison items. Rather, the steps S22 to S24 may be executed in any order.

### Comparison of Work Periods

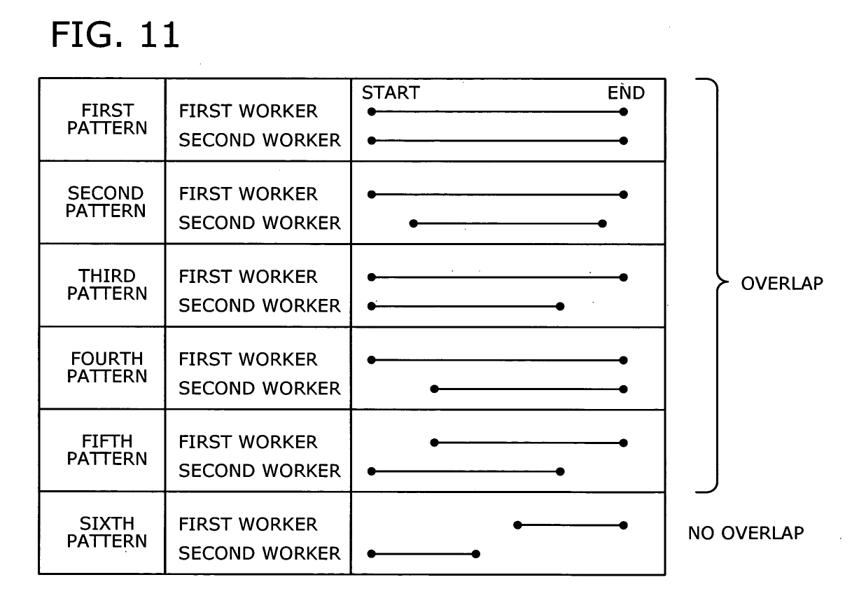

FIG. 11 shows six patterns of work periods of first and second workers. Each pattern is illustrated with a first worker's work period in the upper half and a second worker's work period in the lower half.

The first pattern is when the two workers' work periods begin at the same time and end at the same time. The teamwork analyzer 140 identifies the work periods as overlapping.

The present embodiment actually sets a certain amount of tolerance (e.g., ten percent) for the difference between two work periods being compared. The ten-percent tolerance means that the two work periods will be regarded as identical if their difference in start time or end time is not greater than ten percent of the work time length of the first worker. In the case where, for example, the work period is 60 minutes in length, two work periods with a difference of six minutes or smaller are regarded as identical. In addition to the relative percentage tolerance, the present embodiment also defines an absolute tolerance of one minute, for example. This means that two work periods with a difference of one minute or smaller are regarded as identical if their lengths are ten minutes or shorter. The amount of such tolerance is previously given as a configuration parameter for the teamwork analyzer 140.

The second pattern is when the second worker's work period is contained within the first worker's. The teamwork analyzer 140 identifies this pattern of work periods as overlapping.

The third pattern is when the first and second workers' work periods begin at the same time, but the latter ends earlier than the former. The teamwork analyzer 140 also identifies this pattern of work periods as overlapping.

The fourth pattern is when the second worker's work period begins later than the first worker's, but both periods end at the same time. The teamwork analyzer 140 also identifies this pattern of work periods as overlapping.

The fifth pattern is when one worker's work period begins and ends later than the other worker's. The teamwork analyzer 140 also identifies this pattern of work periods as overlapping.

The sixth pattern is when one worker's work period ends before the other worker's work period begins. The teamwork analyzer 140 identifies this pattern of work periods as non-overlapping.

### Comparison of Workplaces

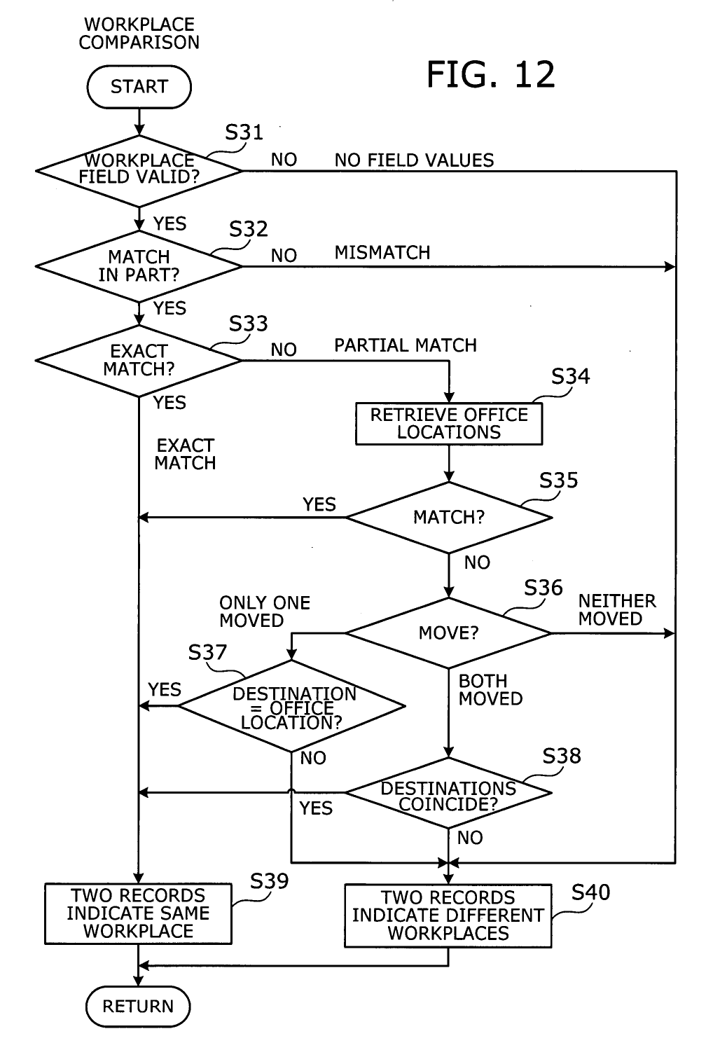

Referring to the flowchart of FIG. 12, this section gives details of the process of comparing workplaces. Specifically, the process of FIG. 12 compares workplaces given in two individual work log records according to the following steps:

(Step S31) The teamwork analyzer 140 determines whether both the first worker's work log record and second worker's work log record have a valid workplace field. If so, the process advances to step S32. If either or both lack the field, the process branches to step S40.

(Step S32) The teamwork analyzer 140 determines whether the two workplace fields match at least in part. More specifically, it tests whether one workplace field includes a character string of the other workplace description. If such a character string is found, the process advances to step S33. If there are no such strings, the process branches to step S40.

(Step S33) The teamwork analyzer 140 determines whether the workplace fields exactly match with each other. If so, the process advances to step S39. If not, the process proceeds to step S34.

Suppose, for example, that the first worker's log record gives “C615 meeting room” whereas the second worker's log record gives simply “C615.” In this case, step S32 determines that they match partly, and then step S33 determines that they do not match exactly, thus choosing S34 as the next step to take.

(Step S34) The teamwork analyzer 140 consults the personnel database 110 for office locations of the first and second workers.

(Step S35) The teamwork analyzer 140 determines whether the office location of the first worker matches with that of the second worker. If so, the process branches to step S39. If not, the process proceeds to step S36.

(Step S36) The teamwork analyzer 140 consults other work log records of each worker to determine whether the workers took any trip in the same day. More specifically, the teamwork analyzer 140 searches the individual work log database 130 for other log records having the same worker name field and the same date field as the log record of interest, but indicating an earlier end time than the start time of that record. The teamwork analyzer 140 now looks into the description field of those records to see whether they include the word “move” or its synonyms. If such records are found, then the teamwork analyzer 140 selects the one having the latest end time. The selected log record indicates the last trip that the worker took before he/she began the activity described the log record of interest. The teamwork analyzer 140 thus interprets the workplace of the selected record as the destination of his/her trip.

In this way, movement of a worker is detected as the presence of the word “move” is found in his/her individual work log record of an earlier time in the same day. The absence of such records, on the other hand, indicates no movement of that worker. If the log records show that only one worker moved, then the process advances to step S37. If the records show that both workers moved, then the process advances to step S38. If the records show that neither moved, then the process skips to step S40.

(Step S37) Now that it has turned out that only one worker moved, the teamwork analyzer 140 determines whether the destination of that movement coincides with the office location of the other, unmoved worker. For this comparison, the teamwork analyzer 140 looks into the workplace field of the individual work log record implying the movement, thus identifying the destination. The teamwork analyzer 140 also consults the personnel database 110 for the office location of the other worker. If the destination coincides with the office location, the process advances to step S39. If not, the process proceeds to step S40.

(Step S38) Now that it has turned out that both workers moved, the teamwork analyzer 140 determines whether their destinations coincide with each other. If so, the process advances to step the process advances to step S39. If not, the process proceeds to step S40.

(Step S39) The teamwork analyzer 140 exits from the process of FIG. 12 with a conclusion that the individual work log records of the first and second workers indicate the same workplace.

(Step S40) The teamwork analyzer 140 exits from the process of FIG. 12 with a conclusion that the individual work log records of the first and second workers indicate different workplaces.

### Teamwork Log Record

Referring now to the flowchart of FIG. 13, this section describes a process of generating teamwork log records. The process of FIG. 13 proceeds according to the following steps:

(Step S51) The teamwork analyzer 140 consults the individual work log database 130 to determine whether a teamwork flag is set to one in the first worker's individual work log record selected at step S12 of FIG. 9. If the teamwork flag is set, then the process advances to step S55. If not, the process proceeds to step S52.

(Step S52) The teamwork analyzer 140 adds a new teamwork log record to the teamwork log database 150. More specifically, the teamwork analyzer 140 compiles a new record by filling in the data fields of “date,” “start time,” “end time,” “time length,” “description”, and “workplace” with the information about the first worker's activity. The teamwork analyzer 140 further puts the names of the first and second workers identified at step S11 (FIG. 9) into the participant field of the new record. Subsequently the teamwork analyzer 140 registers the first worker's name as a main worker in the record. In the case of the first pattern of overlapping work periods (see FIG. 11), the teamwork analyzer 140 adds the second worker's name as another main worker. The teamwork analyzer 140 further fills in the work pattern field of the new record with a pattern identifier indicating how the work periods overlap. More specifically, pattern identifiers ranging from “1” to “6” are defined corresponding to the first to sixth patterns discussed in FIG. 9. Finally, the teamwork analyzer 140 gives the new teamwork log record a teamwork ID (serial number).

(Step S53) The teamwork analyzer 140 updates the individual work log record of the first worker in the individual work log database 130 by setting a teamwork flag and entering the teamwork ID of the new teamwork log record created at step S52.

(Step S54) The teamwork analyzer 140 updates the second worker's individual work log in the individual work log database 130 that has been identified as part of a teamwork activity, by setting a teamwork flag and entering the teamwork ID of the new teamwork log record created at step S52. The teamwork analyzer 140 then exits from the present process.

(Step S55) The teamwork analyzer 140 selects one or more teamwork log records corresponding to the teamwork ID(s) set in the currently selected individual work log record of the first worker. More specifically, the teamwork analyzer 140 consults the teamwork log database 150 to extract a teamwork log record(s) with a teamwork ID(s) found in the teamwork ID field of the selected individual work log record. (Note that an individual work log record may contain two or more teamwork IDs.) The teamwork log records extracted in this way are subjected to the following processing steps S56-S60.

(Step S56) The teamwork analyzer 140 compares the work period described in each of the teamwork log records extracted at step S55 with that described in the selected individual work log record of the first worker. If there is a teamwork log record that gives a comparison result equivalent to the first pattern (i.e., exact match in both start and end times) discussed in FIG. 11, the teamwork analyzer 140 advances the process to step S57. If there are no such records, the process proceeds to step S58.

(Step S57) The teamwork analyzer 140 adds the second worker's name to the found teamwork log record as another participant of that teamwork activity. The process then proceeds to step S59.

(Step S58) The teamwork analyzer 140 adds a new teamwork log record. More specifically, the teamwork analyzer 140 compiles a new record by filling in the data fields of “date,” “start time,” “end time,” “time length,” “description”, and “workplace” with the information described in the first worker's individual work log record. The teamwork analyzer 140 further puts the names of the first and second workers identified at step S11 (FIG. 9) into the participant field of the new teamwork log record. Subsequently the teamwork analyzer 140 registers the first worker's name as a main worker in the record. In the case where the step S21 (FIG. 10) has discovered the first pattern of overlapping work periods (FIG. 11), the teamwork analyzer 140 also adds the second worker's name as another main worker. The teamwork analyzer 140 further fills in the work pattern field of the new record with the pattern identifier determined at step S56, thus indicating how the work periods overlap. Finally, the teamwork analyzer 140 gives the new teamwork log record a teamwork ID (serial number).

(Step S59) The teamwork analyzer 140 updates the first worker's individual work log record in the individual work log database 130 that has been identified as part of a teamwork activity, by entering the teamwork ID of the new teamwork log record created at step S58.

(Step S60) The teamwork analyzer 140 updates the second worker's individual work log record in the individual work log database 130 that has been identified as part of a teamwork activity, by setting a teamwork flag and entering the teamwork ID of the new teamwork log record created at step S58. The teamwork analyzer 140 then exits from the present process of FIG. 13.

### Example of Teamwork Log Records

The process described in the above section compiles a teamwork log. This section gives some more specific examples of that process, assuming individual work log records shown in FIG. 8.

(1) First Worker Pair (A+B)

This example assumes that worker-A and worker-B are selected as first and second workers, respectively, at step S11 of FIG. 9, and that an individual work log record #10 is selected at step S12. The teamwork finding process shown in FIG. 10 then chooses at step S21 an individual work log record #11 of the second worker (worker-B) as sharing a work period with the selected record #10.

The teamwork analyzer 140 finds these two log records #10 and #11 to be of a teamwork activity from the fact that their description fields match with each other. Since the teamwork flag field of the worker-A's log record is blank at this point in time, the teamwork analyzer 140 adds a new teamwork log record to the teamwork log database 150.

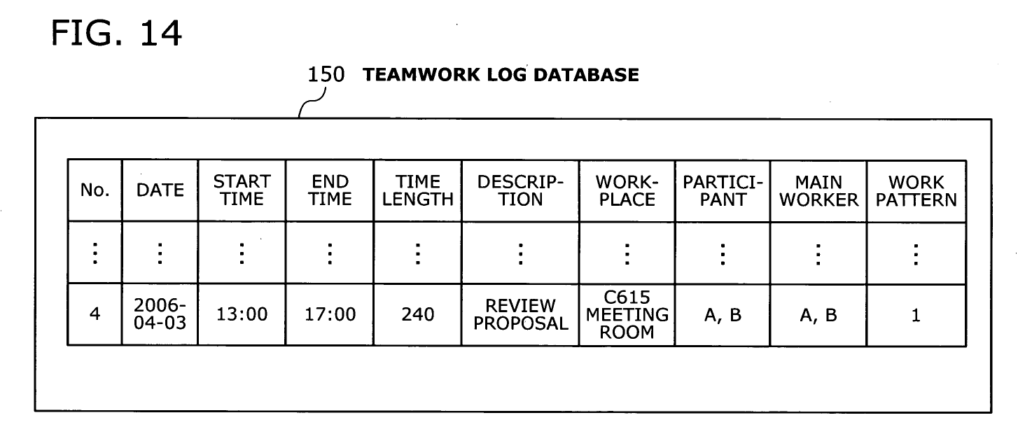

FIG. 14 shows an example data structure of the teamwork log database 150. This teamwork log database 150 is illustrated in the form of a table with the following data fields: “No.” (number), “Date,” “Start Time,” “End Time,” “Time Length,” “Description,” “Workplace,” “Participant,” “Main Worker,” and “Work Pattern.” Each row (i.e., a set of associated data fields) of this table constitutes a single record describing a particular teamwork activity.

The number field contains a number that uniquely identifies a particular teamwork log record, which is referred to as a “teamwork ID.” The start time and end time fields show when the teamwork activity began and finished, and the time length field gives its duration in units of minutes. The description field gives a brief description of the teamwork activity. The workplace field shows where the activity took place. The participant field shows the names of workers involved in the activity. The main worker field shows the names of workers who participated in the activity throughout the work period.

FIG. 14 shows a new teamwork log record added next to the existing records #1 to #3 (details omitted). This new record with a teamwork ID of “4” has been created from individual work log records #10 and #11 in the individual work log database 130. The date, start time, end time, time length, description, and workplace fields contain a copy of their counterpart in the individual work log record #10. The participant field shows that worker-A and worker-B were involved in the teamwork activity.

Since the two individual work log records #10 and #11 have an overlapping relationship of the first pattern in their work periods, the new teamwork log record of FIG. 14 contains the names of worker-A and worker-B in its main worker field and an identifier “1” in its work pattern field to indicate the first pattern of overlapping work periods.

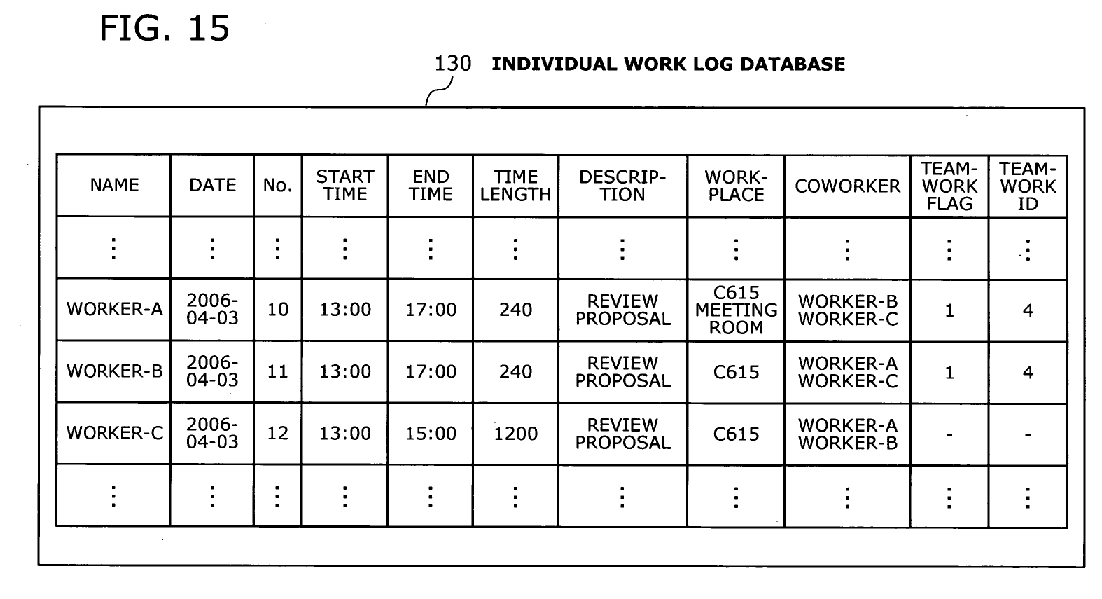

After the above-described teamwork log record is added to the teamwork log database 150, the teamwork analyzer 140 gives a teamwork flag and a teamwork ID to the individual work log records #10 and #11 in the individual work log database 130. FIG. 15 shows the updated individual work log records #10 and #11 with a teamwork flag and a teamwork ID. Specifically, the individual work log record #10 has “1” in its teamwork flag field and “4” in its teamwork ID field, as does the individual work log record #11.

(2) Second Worker Pair (B+C)

This example assumes that worker-B and worker-C are selected as first and second workers, respectively, at step S11 of FIG. 9, and that an individual work log record #11 is selected at step S12. The teamwork finding process shown in FIG. 10 then chooses at step S21 an individual work log record #12 of the second worker (worker-C) as sharing a work period with the selected record #11.

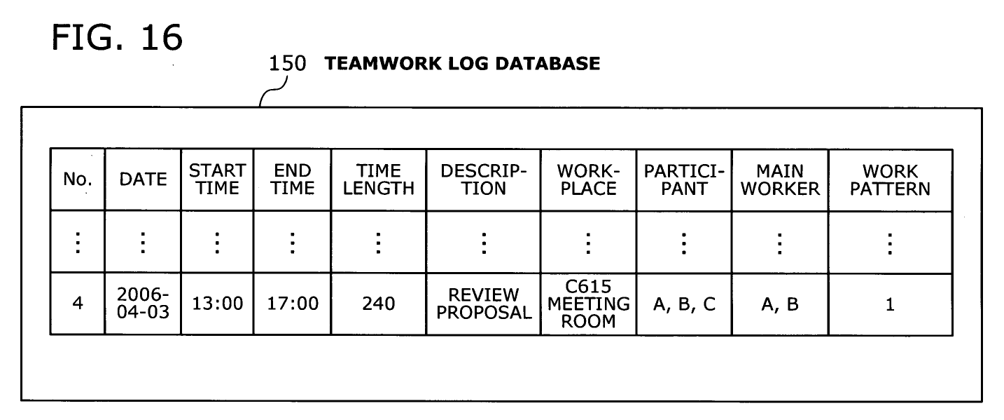

The teamwork analyzer 140 finds these two log records #11 and #12 to be of a teamwork activity from the fact that their description fields match with each other. The teamwork analyzer 140 also finds that the worker-B's individual work log record #11 has a teamwork flag set to one (FIG. 15). This fact causes the teamwork analyzer 140 to compare the existing teamwork log record #4 with the individual work log record #11 to test their relationship. Since the comparison reveals that they have overlapping work periods of the first pattern, the teamwork analyzer 140 adds worker-C to the participant field of the teamwork log record #4. FIG. 16 shows the teamwork log database 150 updated with a new participant name. As can be seen by comparing FIG. 16 with FIG. 14, the name “C” appears in the participant field of the teamwork log record #4.

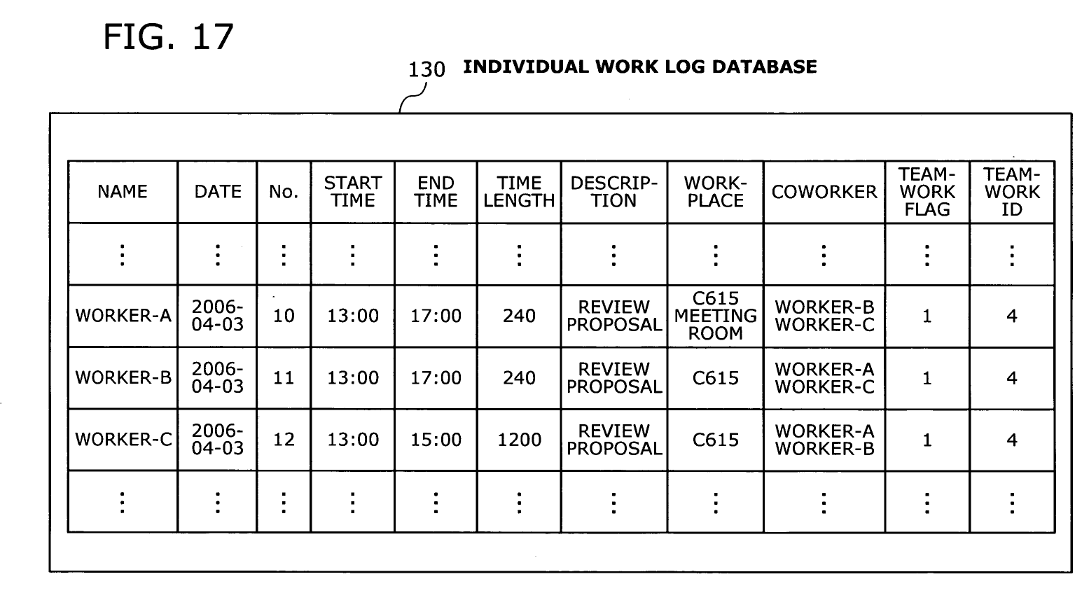

The teamwork analyzer 140 also updates the individual work log record #12 in the individual work log database 130 as shown in FIG. 17. Specifically, the teamwork flag of the record #12 is set to “1,” and the teamwork ID field of same is given a value of “4.”

(3) Third Worker Pair (C+A)

This example assumes that worker-C and worker-A are selected as first and second workers, respectively, at step S11 of FIG. 9, and that an individual work log record #12 is selected at step S12. The teamwork finding process shown in FIG. 10 then chooses at step S21 an individual work log record #10 of the second worker (worker-A) as sharing a work period with the selected record #12.

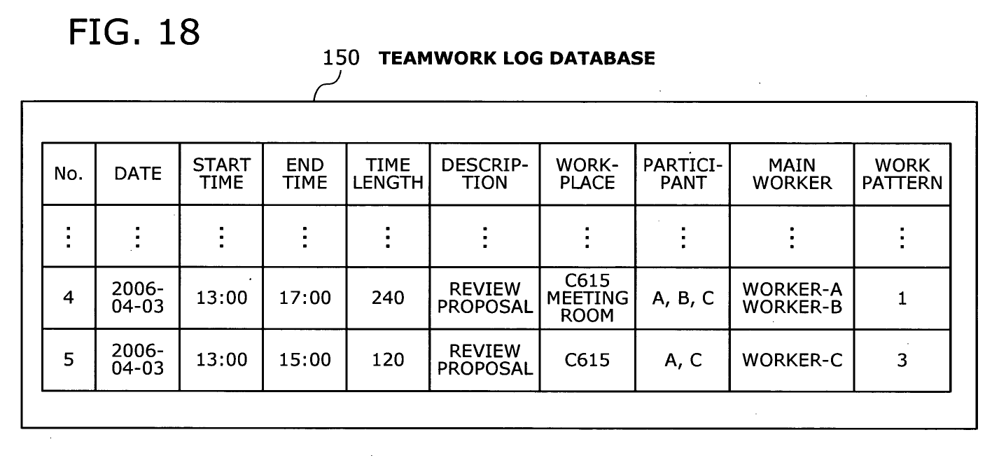

The teamwork analyzer 140 finds these two log records #12 and #10 to be of a teamwork activity from the fact that their description fields match with each other. The teamwork analyzer 140 also finds that the worker-C's individual work log record #12 has a teamwork flag with a value of one (FIG. 17). This fact causes the teamwork analyzer 140 to compare the teamwork log record #4 with the individual work log record #12 to test their relationship. Since the comparison reveals that they have an overlap of the third pattern, the teamwork analyzer 140 adds a new teamwork log record to the teamwork log database 150. FIG. 18 shows the teamwork log database 150 with a new entry of record. The newly added teamwork log record bears a teamwork ID of “5.” The date, start time, end time, time length, description, and workplace fields are copied from their counterpart in the individual work log record #12 that the individual work log database 130 maintains. The participant field shows that worker-A and worker-C are involved in the teamwork activity.

Since the two individual work log records #12 and #10 have an overlapping relationship that falls within the third pattern, the new teamwork log record #5 of FIG. 18 contains the name of worker-C in its main worker field and an identifier “3” in its work pattern field to indicate the third pattern of overlapping work periods.

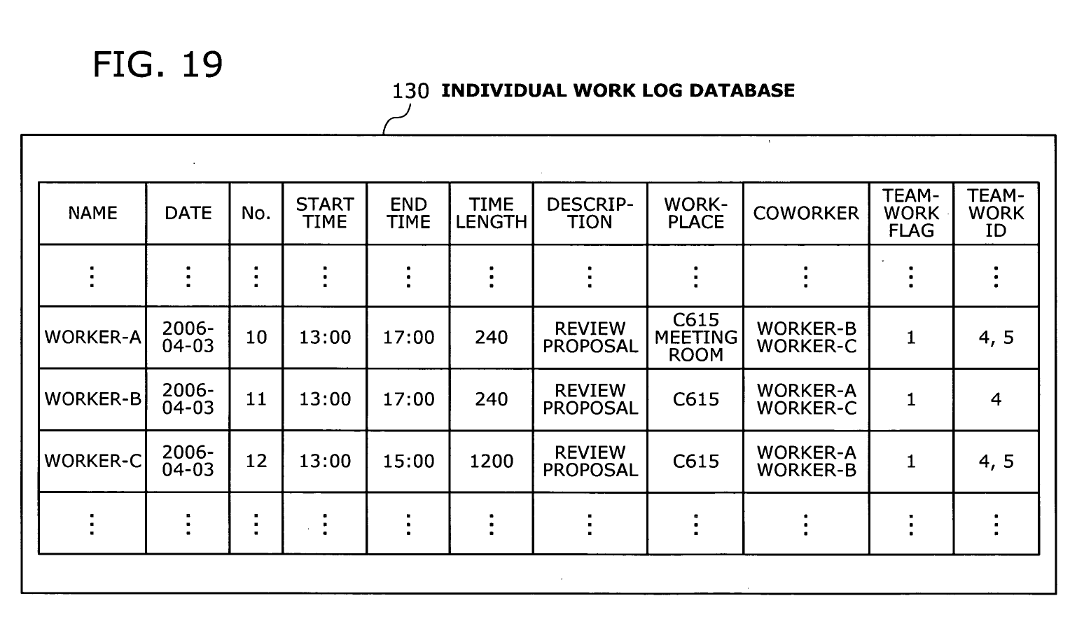

The teamwork analyzer 140 further adds the new teamwork ID to the individual work log records #10 and #12, thus updating the individual work log database 130 as showing in FIG. 19. Specifically, the two records #10 and #12 now contain a value of “5” in their teamwork ID field, together with the existing teamwork ID “4.”

(4) Fourth Worker Pair (B+A)

This worker pair selection is opposite to the first worker pair (A+B) described earlier. That is, it is assumed that worker-B and worker-A are selected as first and second workers, respectively, at step S11 of FIG. 9, and that an individual work log record #11 is selected at step S12. The teamwork analyzer 140 then finds out that an individual work log record #10 of the second worker (worker-A) has a work period overlapping with that of the selected record #11.

In the present example, the individual work log record #11 has a value of “1” in its teamwork flag field and “4” in its teamwork ID field. The relationship between the individual work log record #11 and the teamwork log record #4 is found the first pattern of overlapping work periods. Since the name of worker-A is already included in the existing teamwork log record #4, the teamwork analyzer 140 adds nothing to the teamwork log database 150.

(5) Fifth Worker Pair (C+B)

This worker pair selection is opposite to the second worker pair (B+C) described earlier. That is, it is assumed that worker-C and worker-B are selected as first and second workers, respectively, at step S11 of FIG. 9, and that an individual work log record #12 is selected at step S12. The teamwork analyzer 140 then finds out that an individual work log record #11 of the second worker (worker-B) has a work period overlapping with that of the selected record #12, and that the relationship of those two log records #11 and #12 falls within the third pattern of overlapping work periods.

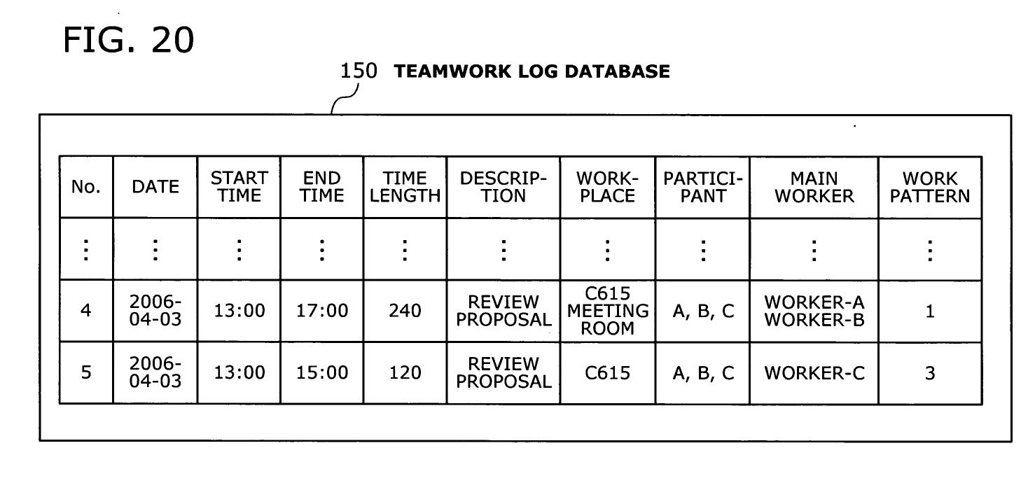

In the present example, the individual work log record #12 has a value of “1” in its teamwork flag field and “4” and “5” in its teamwork ID field. The relationship between the individual work log record #12 and the teamwork log record #5 falls within the first pattern of overlapping work periods. The teamwork analyzer 140 therefore adds the name of worker-B to the participant field of the teamwork log record #5. FIG. 20 shows the teamwork log database 150 with an additional teamwork participant. As can be seen by comparing FIG. 20 with FIG. 18, the name “B” now appears in the participant field of the teamwork log record #5.

(6) Sixth Worker Pair (A+C)

This worker pair selection is opposite to the third worker pair (C+A) described earlier. That is, it is assumed that worker-A and worker-C are selected as first and second workers, respectively, at step S11 of FIG. 9, and that an individual work log record #10 is selected at step S12. The teamwork analyzer 140 then finds out that an individual work log record #12 of the second worker (worker-C) has a work period overlapping with that of the selected record #10, and that the relationship of those two log records #10 and #12 falls within the third pattern of overlapping work periods.

In the present example, the individual work log record #10 has a value of “1” in its teamwork flag field and “4” and “5” in its teamwork ID field. The relationship between the individual work log record #10 and the teamwork log record #4 is found the first pattern of overlapping work periods. Since, however, the name of worker-C is already included in the existing teamwork log record #4, the teamwork analyzer 140 adds nothing to the teamwork log database 150.

### Group Work History

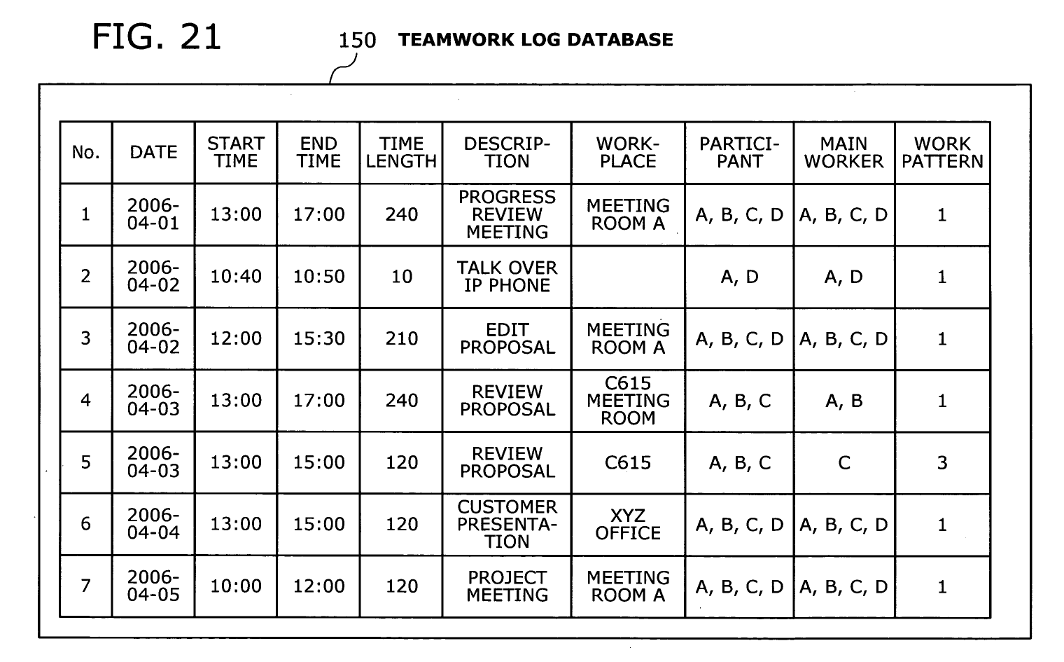

The foregoing sections have explained how a teamwork log for a given time period is created. The created teamwork log is then made available to the group work history generator 160, in which the records are sorted according to the values of date, start time, and end time fields in that order. FIG. 21 shows the teamwork log database 150 after the records are sorted. Specifically, the example of FIG. 21 shows the final result of analyzing records of group activities during a period from Apr. 1, 2006 to Apr. 5, 2006.

Consulting the individual work log database 130 and teamwork log database 150, the group work history generator 160 now produces a group work history that indicates work periods of individual work activities separately from those of teamwork activities along the time axis. The group work history generator 160 then supplies the client 20 with data for display of the group work history. As a result, a group work history window appears on the monitor screen of the client 20.

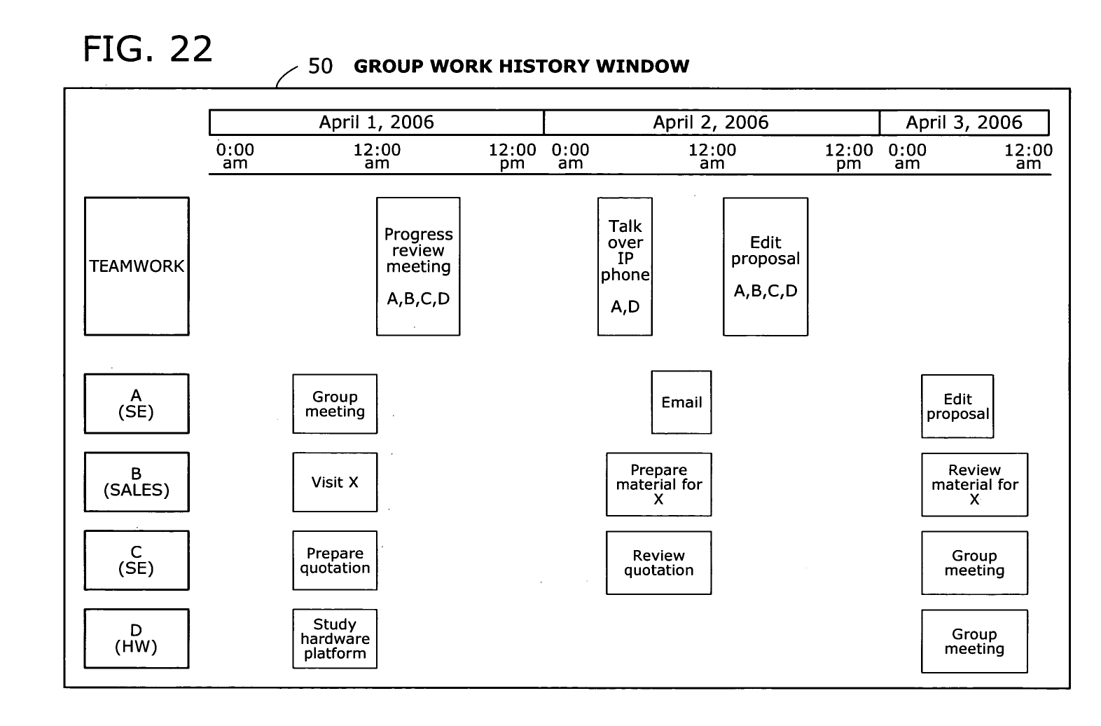

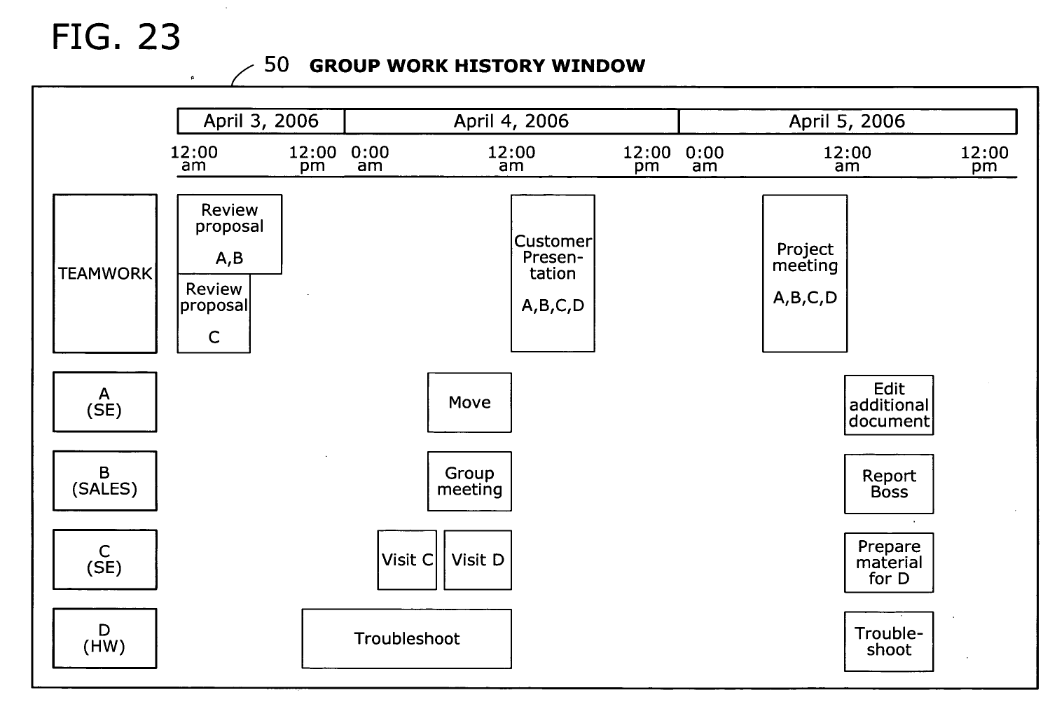

FIGS. 22 and 23 show examples of a group work history window. Specifically, FIGS. 22 and 23 show the work activities performed during the first and second halves of the specified analysis period, respectively. Placed at the top portion of this group work history window 50 are a date bar and a time axis. Group activities and individual activities are represented in the form of boxes arranged along the time axis, each including a brief description. For group activities, the boxes also include the names of participants. While not shown in FIGS. 22 and 23, the boxes may also indicate the workplace of each activity.

In the case where two activities overlap in their work periods, the main worker field of each teamwork log record is used to differentiate groups of participants. Individual activities (i.e., activities whose teamwork flag is set to zero) are extracted from among the log records of group members and displayed in the form of boxes placed below the area of group activities.

The group members hold a wrap-up meeting after their project has been executed. The group work history window 50 described above helps them to review how they worked together and capture lessons learned. Suppose, for example, that the project team failed to make a persuasive presentation of their proposed system to customers, only to find it necessary to come back again with additional documents. The present embodiment of the invention help them figure our why the presentation was unsuccessful (e.g., they did not spend enough time reviewing the proposal).

### Storage Medium for Program Product

The above-described processing functions of the present invention are actually implemented on a computer system, the instructions being encoded and provided in the form of computer programs. A computer system executes such programs to provide the intended functions of the present invention. The programs are stored in a computer-readable medium for the purpose of storage and distribution. Suitable computer-readable storage media include magnetic storage media, optical discs, magneto-optical storage media, and solid state memory devices. Magnetic storage media include hard disk drives (HDD), flexible disks (FD), and magnetic tapes. Optical disc media include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for the distribution of program products. Network-based distribution of software programs may also be possible, in which case several master program files are made available on a server computer for downloading to other computers via a network.

A user computer stores necessary software components in its local storage unit, which have previously been installed from a portable storage media or downloaded from a server computer. The computer executes the programs read out of the local storage unit, thereby performing the programmed functions. As an alternative way of program execution, the computer may execute programs, reading out program codes directly from a portable storage medium. Another alternative method is that the user computer dynamically downloads programs from a server computer when they are demanded and executes them upon delivery.

### CONCLUSION

To summarize the above discussion, the proposed group work analyzer compares individual work log records of two workers. If their work periods overlap and if other data fields of the records coincide at least in part, it determines that the two workers engaged in a teamwork activity. The proposed group work analyzer serves as a useful tool for reviewing group activities performed in the course of a project.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable medium storing a program for analyzing group work activities, the program causing a computer to function as:
an individual work log database that stores individual work log records describing work activities performed by individual workers involved in a project, wherein each of the individual work log records contains a worker ID, work period, and other data fields;
a teamwork finder, responsive to a teamwork analysis request specifying a group of workers, that extracts two workers' individual work log records having overlapping work periods and finds the extracted individual work log records to be of a teamwork activity if the other data fields thereof coincide at least in part;
a teamwork log generator that produces teamwork log records from the individual work log records identified as being of teamwork activities; and
a teamwork log database storing the teamwork log records produced by the teamwork log generator.

2. The computer-readable medium according to claim 1, wherein:
said other data fields include a workplace field; and
the teamwork finder finds the extracted individual work log records to be of a teamwork activity if the workplace fields thereof match with each other.

3. The computer-readable medium according to claim 2, wherein the teamwork finder determines that the extracted individual work log records match in terms of workplaces if office locations of the two workers match with each other, even if the workplace fields match only in part.

4. The computer-readable medium according to claim 2, wherein:
if the extracted individual work log records partly match in the workplace field thereof, the teamwork finder further searches the individual work log database for an earlier individual work log record that indicates movement of one of the two workers to a destination; and
the teamwork finder determines that the extracted individual work log records match in terms of workplaces if the destination of said movement matches with an office location of the other worker having no records of movement.

5. The computer-readable medium according to claim 1, wherein:
said other data fields include a coworker field containing worker IDs of other workers who collaborated on the work activity; and
said teamwork finder finds the extracted individual work log records to be of a teamwork activity if the coworker fields thereof match with each other.

6. The computer-readable medium according to claim 1, wherein:
said other data fields include a description field containing a brief description of the work activity; and
said teamwork finder finds the extracted individual work log records to be of a teamwork activity if the description fields thereof match with each other.

7. The computer-readable medium according to claim 1, wherein:
the teamwork log generator finds a worker whose individual work log record indicates that the worker engaged in the teamwork activity throughout the work period of that teamwork activity; and
the teamwork log generator adds a worker ID of the found worker to a main worker field of the teamwork log record that is produced.

8. The computer-readable medium according to claim 1, wherein:
the teamwork finder gives a flag to the individual work log records that the teamwork finder has identified as not being of teamwork activities; and
the program further causes the computer to function as a group work history generator that produces a group work history by sorting teamwork activities along a time axis based on the teamwork log records stored in the teamwork log database, as well as sorting individual work activities along the time axis based on the individual work log records flagged as non-teamwork activities.

9. A method of analyzing group work activities, comprising:
storing, in an individual work log database, individual work log records describing work activities performed by individual workers involved in a project, wherein each of the individual work log records contains a worker ID, work period, and other data fields;
in response to a teamwork analysis request specifying a group of workers, extracting two workers' individual work log records having overlapping work periods and finding the extracted individual work log records to be of a teamwork activity if the other data fields thereof coincide at least in part;
producing teamwork log records from the individual work log records identified as being of teamwork activities; and
storing the produced teamwork log records in a teamwork log database.

10. An apparatus for analyzing group work activities, comprising:
an individual work log database that stores individual work log records describing work activities performed by individual workers involved in a project, wherein each of the individual work log records contains a worker ID, work period, and other data fields;
a teamwork finder, responsive to a teamwork analysis request specifying a group of workers, that extracts two workers' individual work log records having overlapping work periods and finds the extracted individual work log records to be of a teamwork activity if the other data fields thereof coincide at least in part;
a teamwork log generator that produces teamwork log records from the individual work log records identified as being of teamwork activities; and
a teamwork log database storing the teamwork log records produced by the teamwork log generator.
